(19) United States
(12) Patent Application Publication
(10) Pub. No.: US 2013/0011522 A1
(43) Pub. Date: Jan. 10, 2013

(54) Novel method of making cocktails using tablets, a novel method of selling alcohol, and a novel kit.

(76) Inventor: Lori Schlakman, Englewood, NJ (US)

(21) Appl. No.: 13/507,490

(22) Filed: Jul. 2, 2012

Related U.S. Application Data
(60) Provisional application No. 61/571,616, filed on Jul. 1, 2011.

(51) Int. Cl. C12G 3/06

(52) U.S. Cl. 426/87; 426/592

(57) ABSTRACT

A method to prepare a cocktail using a tablet that contains all the ingredients necessary so that it is capable, when added to a solvent that is comprised of water or a water/alcohol combination such that the alcohol portion is not more than 80% (v/v) (which is equivalent to 160 proof), of creating a flavored cocktail. A method of selling alcohol such that it is sold with a tablet just described. A Kit containing a bottle of alcohol and a tablet as described.

### PRIORITY CLAIM

This application claims priority to provisional patent application filed with the USPTO on Jul. 1, 2011 and bearing application # U.S. 61/571,616 and titled: a novel method of making cocktails using tablets.

### BACKGROUND OF THE INVENTION

Brief statement of the invention:

A novel method for making cocktails, a novel method of selling alcohol, and a novel kit combining a bottle of alcohol and tablets used to make cocktails.

### Background

“Cocktails”, that is cocktail flavored beverages, whether actually containing alcohol or not as in the case of “virgin” cocktails, have existed in the prior art for a long time. Because they sometimes do not contain alcohol, the distinction between these cocktail flavored beverages and other non-cocktail beverages, such as fruit juices, punches, or coffee beverages is a difficult to define matter of taste. Nevertheless, though difficult to define, the distinctions are generally known: a mojito is not lime juice; a bloody mary is not tomato juice, a cosmopolitan is not cranberry juice and a white russian is not coffee.

Though it is common to use the term “cocktail” to refer simply to blends of juices; that is not the way the term “cocktail” is being used herein. Herein “cocktail” is being used to specifically refer to those beverages either commonly made with alcohol (with examples including, but not limited to: martini, margarita, daiquiri, Tom collins, pina collada, mudslide, mojito, kamikaze, bloody mary, cosmopolitan, and white russian) or that attempt to capture the same flavor of such alcoholic beverages while not incorporating alcohol.

It is a critical feature of the invention that the tablet utilized in the method of preparing cocktails contains all the ingredients necessary, other than the water and alcohol, so that it can be used to prepare a flavored cocktail without further additions.

It is a critical feature of certain embodiments of the invention, including the preferred embodiment, that the authentic flavors of classic or standard cocktails be captured in the cocktails prepared in accordance with this invention.

### Statement of the Problem that is Being Solved by this Invention

It has been noted, particularly in United States Patent Application Publication US2009/0288965, that it is difficult to prepare mixed drinks in “field” conditions such as at the beach, in a bus, on a plane, while tailgating in a parking lot prior to a sporting event. While the invention disclosed in that publication attempts to solve the problem at hand by using a particular container, the instant invention addresses similar concerns from a wholly different direction. That publication goes on to discuss particular problems associated with mixing drinks (the “cocktails” of this invention) noting that the person mixing the drink might be a novice bartender (or a party host, or a flight attendant) and may not know precisely how much alcohol to add—which can result in a drink that is not properly enjoyed.

In addition to the problem of not quite knowing the proper mixer/alcohol ratios, mixing can be messy, things can spill. Even if the mixer is a powder, other utensils are needed, it takes time to measure, powder will need to be very carefully transferred from its storage container to the container containing the alcohol. In addition, the ingredients required to prepare said mixed drink must be preassembled and require a significant amount of storage space.

Other technologies have also responded to similar concerns and found different modes of response.

A number of processes have been proposed in the prior art for producing cocktails. These processes range from infusing the beverages with flavors from raw materials such as fruits, chocolate, and coffee, to utilizing commercially available premixed liquid or syrup flavorings. There are also commercially available flavored powders for mixing into a liquid to create cocktails.

Examples of Patents and publications that discuss methods of making alcoholic and non-alcoholic beverages include:

U.S. Pat. No. 3,647,472 to Speech discloses a non-alcoholic beverage mix packaged in predetermined amounts which can be stored under freezing temperature conditions, in a frozen slush form, and which can be combined with a selected alcoholic distillate or a selected nonalcoholic liquid ingredient, to form a chilled cocktail or beverage without the addition of other ingredients.

U.S. Pat. No. 4,233,334 to Owades discloses a dry powdered beverage mix adapted to be reconstituted by the addition of cold water at the time of consumption to provide a fruit flavored beverage.

U.S. Pat. No. 2,728,673 to Mouton discloses a method for making a dry powder concentrate which can be formed into alcoholic beverages by adding alcohol or into non-alcoholic beverages by adding water.

Tablets (defined to include both tablets and capsules) in various shapes and sizes have also existed in the prior art for a long time. They are commonly used as delivery systems for medications and vitamin supplements. They have been made to be ingested whole as a solid dosage form, to be chewed, and even to disperse their contents into liquid mediums like in the case of effervescent tablets.

Examples of patents referencing tablets include:
1. U.S. Pat. No. 536,155 to Noyes discloses an early example of a tablet with an effervescent coating.
2. U.S. Pat. No. 3,679,794 to Bentholm discloses very rapidly disintegrating tablets intended as solid dosage forms for medications or nutrients.
3. U.S. Pat. No. 2,851,361 to Diller discloses tablets used to make carbonated beverages by adding the tablet to water.
4. U.S. Pat. No. 5,254,355 to Smith discloses sugar-free tablets used to make flavored beverages. The disclosure gives lemon, fruit-flavored beverage tablets and iced-tea flavored beverage tablets as examples.
5. U.S. Pat. No. 4,975,295 to Sierra discloses tablets used to make coffee.
6. U.S. Pat. No. 5,686,107 to Ratnaraj discloses chewable tablets intended for pharmaceutical uses such as medications, vitamins, and antacids.

One tablet, found at US Patent application publication 2002/0136816 was described as being able to create beer when added to water; though not a cocktail normally made with beer.

It has even been known that flavored tablets could be dropped into alcoholic beverages to create flavored alcoholic beverages; however, such tablets never contained all of the ingredients necessary (other than the water and the alcohol) to create a cocktail and even more so, such tablets were never capable of creating cocktails with the authentic flavors of those prepared in more traditional manners. See for example US Patent Application Publication 20120052158 which noted that “Flavoring agents of any desirable type and in any desirable quantity may be used, whether alone or in combination. In certain embodiments, flavoring agents comprise any of fruit flavorings and/or fruit extracts, herbs and/or herb extracts, spices and/or spice extracts; flowers and/or flower extracts; milk, cream, sauces, yeasts and/or yeast extracts, and grains and/or grain extracts In certain embodiments, beverage mixers including flavoring agents are arranged for addition to beverages including distilled spirits.” The primary focus of the invention disclosed in that application was to remove the deleterious effects of alcohol consumption such as headache, hangover, and liver damage. It is never disclosed that the tablet would be a complete repository of all ingredients other than the alcohol and water and it certainly never disclosed that the authentic flavor of classical cocktails can be created using tablets.

In a similar vein, on the Amerilab Technologies, Inc. website there is a you-tube video which is described as having been aired on the Food Network's Unwrapped. Beginning at approximately the 2 minute 13 second mark of that video, it is described that some people take Fizzies® and drop them in a martini glass and make a “fizzietini.” That video can be found at http://www.fizzies.com/news.html. Though those tablets are being used to enhance the flavor of alcoholic beverages, they do not capture the authentic flavor classical cocktails. They do not contain all the ingredients necessary.

### DESCRIPTION OF THE INVENTION

While tablets have been used for many purposes and Cocktails have been prepared in many ways, never has it been suggested that tablets hold all the ingredients necessary to make cocktails or especially be used to make cocktails with authentic cocktail flavorings. As discussed earlier, this is even though there are many reasons to want to make cocktails by using tablets such as preventing spills, minimizing storage space, and getting the proper ratios into the cocktail.

To answer this long unanswered need, the inventors herein have invented a novel process of making cocktails: that process involves utilizing the same types of tablet, whether disintegrating, or dissolving or effervescing that have previously been disclosed in the prior art and that can be made by those skilled in the art of making such tablets and combining into the tablet, an effective amount of flavoring, instead of a medication, or a vitamin or a cleaning agent, such that when combined with alcohol and water the result is an authentically flavored cocktail.

It has never before been suggested to use tablets in this manner. Some of the benefits of this method include: 1) ability of the tablets to be packaged in a manner that allows for being presented as a gift; 2) the ability for small light weight packaging reduces waste from large plastic “mixer” bottles; 3) the ability for convenient sleek lightweight packaging allows you to take with you where-ever when-ever and can be stocked at retail level without added shelf space and allows for relatively cheaper shipping than other cocktail methods; 4) because of the ability to be packaged using small lightweight packaging, they can easily be stocked on airlines and cruises as well as in theaters and hotels; 5) because of the ability to make a “complete” and consistent cocktail using only a tablet and without any bartender allows restaurants and other food retailers and chains, as well as the above mentioned airlines and hotels to serve cocktails and retain consistency of drink and service without having to hire and train specified staff; 6) Versatility, the method can be used in any spirit base to create a full cocktail experience including, but not limited to beer, sake, wine, and vodka; 7) the method can be used in a very strong spirit base such as Baijiu to allow the spirit to be palatable for a wider range of consumers.

Though tablets have been used to make other types of beverages such as carbonated beverages, fizzie punches, vitamin and energy drinks, and even flavored alcoholic beverages, it has never been suggested that tablets can incorporate all necessary ingredients and be used to prepare cocktails especially those with authentic cocktail flavors. One practical reason why this has been so is that it has been difficult to design a tablet that will dissolve in an alcohol based beverage in a commercially reasonable amount of time such that a consumer can place a tablet in a beverage and then within a short time enjoy an authentic tasting cocktail.

Thus the amount of time that the tablet takes to dissolve in the beverage is an important feature of the invention.

Also inherently important in the invention is a balance of ingredients so that the cocktail may be authentically flavored by the substantial elimination of the taste of the tablet's excipients.

Another important feature of the invention is that in addition to the flavors of the cocktails, the invention in its preferred embodiment will also release coloring agents when combined with water and alcohol. These coloring agents will give the cocktails an authentic appearance and will make the cocktail more visually appealing.

Thus in the preferred embodiment of the invention a person will be able to make a cocktail with authentic flavors and colors just by combining a tablet with water and/or alcohol.

Other features of the preferred embodiment include: 1) CO2 being released forming a pleasing display and enhancing the flavors; 2) No stirring, shaking or other mixing necessary; 3) low calorie tablets.

### The Method:

A person practicing the invention will obtain, from whatever source, a tablet containing all the ingredients necessary to prepare a flavored cocktail, the tablet will be placed into a container in which will also be placed either water or an alcohol/water combination such that the amount of alcohol is not more than 80% (v/v)(being not more than 160 proof). After the tablet has dissolved, additional water or alcohol may be added as desired. Additionally, the cocktail may be mixed if desired.

For the this method, the water portion of the cocktail is defined herein to be any consumable liquid (other than ethanol or other potable alcohol; however, as defined herein, water does include the non-alcoholic portions of an alcoholic beverage such that, for example a vodka that is 40% alcohol (80 proof), is defined to be 60% water) commonly used in preparing cocktails such as for example: club-soda, ginger-ale, cola, milk, etc. As it pertains to the preferred embodiment however, the term water is defined to only be actual water.

The Alcohol portion of the cocktail is defined herein to be ethanol or other potable alcohol and can be sourced from any consumable alcohol used in making cocktails, for example: neutral spirits, vodka, gin, rum, tequila, scotch, whiskey, wine, beer, liquors such as amaretto, Southern Comfort®, Baileys®, etc. (as in the example from the previous paragraph, a vodka that is 40% alcohol (80 proof) is only defined to be 40% alcohol, so that if there were 1 fluid ounce of that vodka, there would only be 4/10 of a fluid ounce of alcohol). Where however, “alcohol” is used in conjunction with a “bottle”, such as in “a bottle of alcohol” in the method of selling and the kit inventions also contained in this patent, it is to be understood colloquially, so that one bottle of vodka would be one bottle of alcohol.

### The Tablet:

Although the method allows for the use of any tablet which when dissolved as described yields a flavored cocktail, the tablets herein disclosed only as examples, do just that:

A tablet, suitable for making a wild berry ginger pom-tini when dissolved in water and vodka, essentially contains in effective ratios:

Component

Citric Acid
Sodium Bicarbonate
Sorbitol
POM Wild Berry Ginger Flavor
PEG-180
Sodium Benzoate
Aspartame
Acesulfame Potassium
Lecithin
Red # 3 Dye
Blue # 2 Dye
Red # 40 Dye

The POM Wild Berry Ginger Flavor essentially consists of the following in effective ratios:

Component

Maltodextrin
Gum acacia
Propylene glycol alginate
Capric/caprylic triglycerides
Fluid extracts
Natural flavors
Ginger oil

The Tablet is effervescent.

In the preferred embodiments, the method would call for the use of any tablet which when dissolved as described yields an authentically flavored cocktail, the tablets herein disclosed only as examples, do just that.

The preferred method has 1½ oz. 80 proof alcohol (defined herein as being 40% v/v alcohol), 1½ oz. water (so that the final liquid portion contains 20% v/v alcohol) and one effervescent tablet. The tablet will be dropped into the water portion only. There it will effervesce and release the flavor and color; that process will take less than about 2 minutes. After the tablet has fully dissolved, the alcohol portion will be added.

As previously noted, the method of this invention involves utilizing the same types of tablet, whether disintegrating, or dissolving or effervescing that have previously been disclosed in the prior art and that can be made by those skilled in the art of making such tablets and combining into the tablet, an effective amount of flavoring.

The preferred tablet for a Mojito essentially contains in effective ratios:

Component

Citric Acid
Sodium Bicarbonate
Sorbitol
Mojito Flavor
PEG-180
Sodium Benzoate
Aspartame
Acesulfame Potassium
Lecithin
Blue # 1 Dye
Yellow # 5 Dye

The Mojito flavoring essentially consists of the following in effective ratios:

Component

Maltodextrin
Gum acacia
Propylene glycol alginate
Capric/caprylic triglycerides
Lime oil
Spearmint oil
Natural flavors

For a Mojito, the preferred alcohol is rum.

The Preferred tablet for a Margarita essentially contains in effective ratios:

Component

Citric Acid
Sodium Bicarbonate
Sorbitol
Margarita Flavor
PEG-180
Sodium Benzoate
Aspartame
Acesulfame Potassium
Lecithin
Yellow # 5 Dye
Yellow # 6 Dye
Blue # 1 Dye

The Margarita flavoring essentially consists of the following in effective ratios:

Component

Maltodextrin
Gum acacia
Propylene glycol alginate
Capric/caprylic triglycerides
Lime oil
Orange oil
Natural flavors

For a Margarita, the preferred alcohol is tequila.

In order to protect the integrity of the product, the tablet is produced in a low humidity atmosphere and packaged in moisture barrier material.

In addition to solving the problems indicated earlier, it has been discovered through market research that making cocktails this way is seen by cocktail drinkers as a creative, innovative, and highly appealing event.

Because of the compact nature of the tablets, and the near ubiquitous availability of water, one only needs to take care of locating the alcohol base, as the tablets are highly transportable and does not take up much shelf space. Also they can be stored in lightweight containers, not ones that are heavy, glass, or plastic, and bulky. This is highly advantageous to the airline and hospitality industry where space and weight are premium considerations. In addition, said product eliminates a significant amount of the waste associated with traditional mixers resulting in an environmentally improved product. Yet another benefit that has been noted is that if one uses an effervescent tablet, as described in the preferred embodiment: its effervescence is not only appealing to the eye, but the effervescent release brings out and enhances some of the flavors that might other wise remain dormant.

It must here be pointed out that in the preferred embodiment, the effervescence of the tablet will dissipate after the dissolution, the final cocktail will not remain “effervescent” or “carbonated” or “bubbly.” The function of the effervescence is to mimic the natural oxygenation that occurs during the pouring and mixing in the classical preparation of cocktails. Without, such steps being necessary here, there is a danger that the final cocktail would be somewhat “flat” and some of the flavors dormant. The effervescence is one way to aerate the final cocktail so that the flavors can be as readily appreciated as in a cocktail prepared in the traditional manner. It is suggested that another way to aerate the final cocktail, in the absence of an effervescent tablets, would be to allow mixing or shaking.

### Method of Selling Alcohol:

In addition to the method of making a cocktail, the invention also includes a method of selling alcohol such that one or more bottles of alcohol will be sold together with one or more tablets that can be utilized for flavoring alcohol to create one or more cocktails.

### Kit:

Finally, the Invention also includes a Kit. The Kit is described as comprising one or more bottles of alcohol and one or more tablets that are capable of being utilized for making flavored cocktails.

Both the Kit and this method of selling alcohol enhance the benefits of being able to create flavored cocktails using tablets that contain all of the necessary ingredients for such cocktails. The method of selling and kit further highlight the utility of having everything necessary for a cocktail all in one small tablet as well as the marketability of a gift pack.

To further highlight the benefits of allowing for a level of giftability: whether packaged as a single serve mini bottle of alcohol with a single tablet or a multi serve full size bottle'of alcohol with multiple tablets, the packaging can contain a “To:” and “From:” label so that consumers can personalize intended gifts.

Similarly, with the applicability of the sales method and kit to various sizes of alcohol and amounts of tablets, they can be used for various types of gifts including but not limited to stocking stuffers on Christmas, gifts for bridal showers, birthdays, and house-warmings.

### ATTACHED ARE A NUMBER OF ILLUSTRATIONS

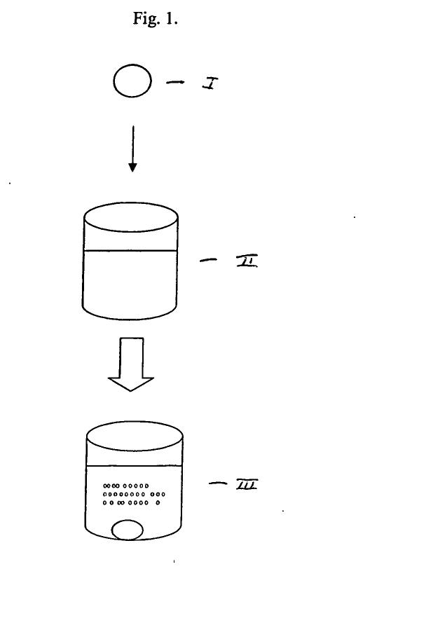

FIG. 1, useful for indicating the method of creating a cocktail using a tablet, illustrates a tablet (“I”) being inserted into a container containing water and alcohol (not more than 160 proof) (“II”) and the resulting container (“III”) with the tablet at the bottom effervescing while it dissolves. As discussed earlier in the description, when the tablet fully dissolves, the effervescence will cease.

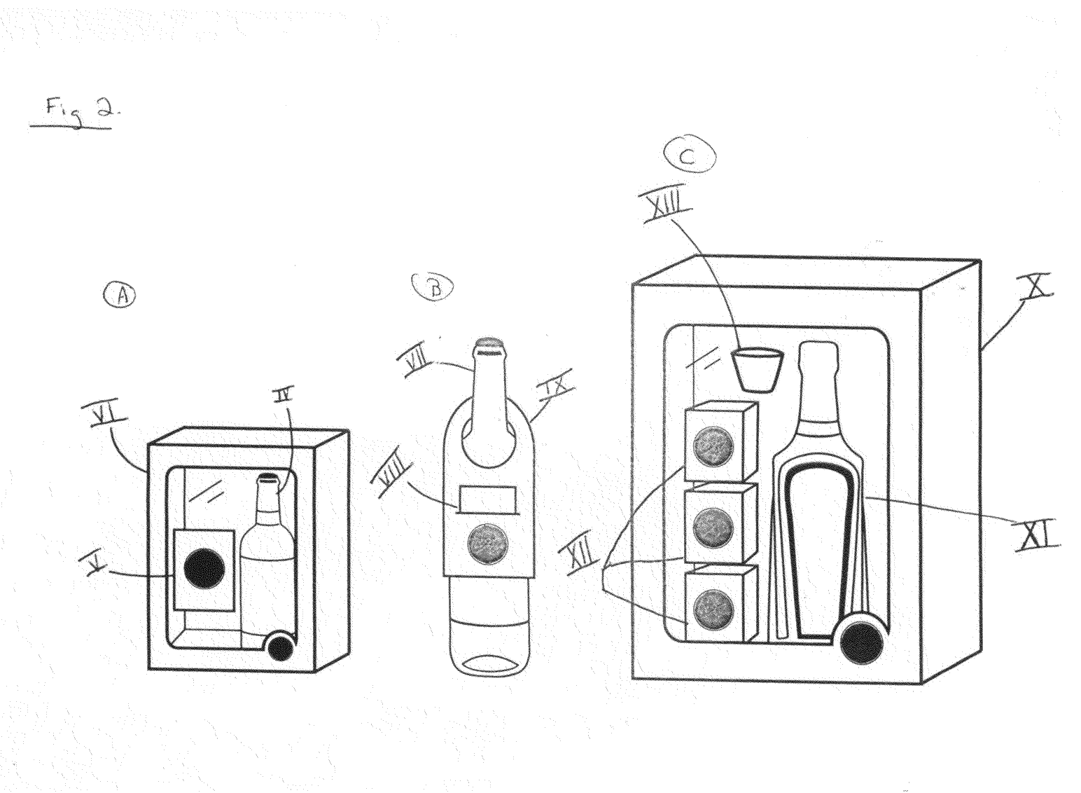

FIG. 2, useful both for illustrating the method of selling alcohol and the Kit has three sub illustrations, a, b, & c.

2a. illustrates one small bottle of alcohol (“IV”) packaged with and intended to be sold with one tablet (“V”) capable of making a cocktail as described further in the description.

2b. also illustrates one bottle of alcohol (“VII”) packaged with and intended to be sold with one tablet (“VIII”) capable of making a cocktail as described further in the description.

2a and 2b differ in that in 2a, the bottle and tablet are both inside a box (“VI”); while in 2b, the tablet is inside a pouch (“IX”) that hangs around the neck of the bottle. These are just 2 of the many possible ways of having a kit as described in the invention and of selling a bottle of alcohol together with a tablet capable of making cocktails.

2c. is similar to 2a in that it uses a box (“X”) to encase a bottle of alcohol (“XI”) and the tablets (“XII”), but in 2c, there are multiple tablets instead of just one. Again, this is just one of the many possible ways of having a kit as described in the invention and of selling bottles of alcohol together with tablets capable of making cocktails. 2c also shows (“XIII”) which is a shot glass; it is included in the illustration simply to illustrate that other items can be included with the bottle and the tablet to further enhance the giftability of the invention.

I claim:

1. A method of preparing cocktails comprising the steps of:
a. obtaining a tablet containing any and all necessary ingredients such that it is capable, when added to a solvent that is comprised of water or a water/alcohol combination such that the alcohol is not more than 80% (v/v)(which is equivalent to 160 Proof), of creating a flavored cocktail,
b. combining said tablet in a container with a sufficient amount of solvent wherein said solvent is comprised of water or a water/alcohol combination such that the alcohol is not more than 80% (v/v)(which is equivalent to 160 Proof),
c. allowing sufficient time for the flavor (and optionally color) to be released from the tablet into the solvent,
d. adding additional alcohol to the solution so that the final cocktail is at a desired strength.

2. The method of claim 1 wherein the tablet contains all necessary ingredients such that it is capable, when added to a solvent that is comprised of water or a water/alcohol combination such that the alcohol is not more than 80% (v/v)(which is equivalent to 160 Proof), of creating an authentically flavored cocktail.

3. The method of either claim 1 or claim 2 wherein the solvent of step b is comprised of a water/alcohol combination such that the alcohol is 20% (v/v) (which is equivalent to 40 Proof).

4. The method of either claim 1 or claim 2 wherein the solvent of step b is 1½ fluid ounces of essentially 100% water and the alcohol added in step d is 1½ fluid ounces of essentially 40% (v/v)(that is 80 proof) alcohol so that the final alcohol % is at 20% (v/v) (that is 40 proof).

5. The method of any of claims 1-4 which further comprises an additional step of mixing the cocktail after which can be inserted at any time after step b.

6. A Method of selling alcohol comprising:
a. Selling one or more bottles of alcohol together with one or more tablets which are capable, when added to a solvent that is comprised of water or a water/alcohol combination such that the alcohol is not more than 80% (v/v)(which is equivalent to 160 Proof), of creating one or more flavored cocktails.

7. A kit comprising one or more bottles of alcohol and one or more tablets which are capable, when added to a solvent that is comprised of water or a water/alcohol combination such that the alcohol is not more than 80% (v/v)(which is equivalent to 160 Proof), of creating one or more flavored cocktails.

8. The Kit of claim 7 further comprising a “to:” and “from:” label.
